(19) United States
(12) Patent Application Publication
(10) Pub. No.: US 2022/0160171 A1
(43) Pub. Date: May 26, 2022

(54) ROTARY ROASTER

(71) Applicant: Jung Won PARK, lncheon (KR)

(72) Inventor: Jung Won PARK, lncheon (KR)

(21) Appl. No.: 17/432,511

(22) PCT Filed: Feb. 4, 2020
(86) PCT No.: PCT/KR2020/001617

§ 371 Date: Aug. 20, 2021

(30) Foreign Application Priority Data
Feb. 21, 2019 (KR) 10-2019-0020325

(51) Int. Cl. A47J 37/04; A47J 36/16

(52) U.S. Cl. CPC A47J 37/043; F24C 7/067; A47J 36/16

(57) ABSTRACT

The present invention relates to a rotary roaster and, more specifically, to a rotary roster comprising: a roasting plate on which food ingredients are placed and roasted; a base member which supports the roasting plate; a rotating means which is installed in the base member to rotate the roasting plate; and a resistance mount, which is placed to be spaced apart from the upper surface of the roasting plate by a predetermined distance while being supported by the edge portion of the base member, and which, when the roasting plate is rotated, contacts and turns over the food ingredients placed on the roasting plate.

### TECHNICAL FIELD

The present invention relates to a rotary roaster, and more particularly, to a rotary roaster including: a roasting plate on which food ingredients are placed and baked; a base member that supports the roasting plate; a rotary unit that is installed in the base member to rotate the roasting plate; and a resistance holder which is disposed to be spaced apart from an upper surface of the roasting plate by a predetermined distance while being supported by an edge of the base member and which, when the roasting plate is rotated, comes into contact with and turns over the food ingredients placed on the roasting plate.

### BACKGROUND ART

In recent years, with economic development, eating habits become richer, and thus cooking using various food ingredients is being developed. According to this trend, various types of cooking utensils are used in general homes and restaurants. Among them, the cooking utensil most widely used by general consumers may be called a roaster by which a user bakes and eats the food ingredients such as meat or grains, and such a roaster generally includes a roasting plate, on which the food ingredients to be cooked are placed and baked, and a base member that supports the roasting plate.

A central hole, which collects heat provided from a heat source such as a charcoal fire or a gas burner and transmits the collected heat to the roasting plate, is formed through a center of the base member, and an oil collecting groove for collecting oil falling from the roasting plate is installed around the central hole.

In such a roaster, rotary roasters configured to allow the heat provided from the heat source to be evenly transmitted to the roasting plate without temperature deviation, and furthermore, to rotate the roasting plate to evenly bake the food ingredients placed on the roasting plate, have been developed.

For example, as shown in FIG. 1, Korean Patent Application Publication No. 10-2004-0091905 (Nov. 3, 2004) discloses a meat roaster including a roasting plate 10 on which food ingredients to be cooked are placed and baked, a base member 20 that supports the roasting plate 10, and a rotary unit that rotates the roasting plate 10.

Here, the rotary unit includes a screw thread 12 that is formed on a bottom surface of an edge of the roasting plate 10, a driving gear 23 that is installed on one side of the base member 20 and engaged with the screw thread 12, and a driving shaft 24 and a driving motor 50 that are installed in the driving gear 23. A description of other non-described reference numerals in FIG. 1 will be omitted.

In addition to the meat roaster of FIG. 1, Korean Patent Registration No. 10-0606462 (Jul. 21, 2006) discloses a meat roaster having a dome-shaped cover that covers a rotatably installed roasting plate so that meat may be baked quickly without splashing meat oil and so as not to quickly cool the baked meat.

Further, Korean Patent Registration No. 10-0549808 (Jan. 31, 2006) discloses an electric roasting plate in which a rotary plate is coupled onto a base plate, a roasting plate which rotates together with the rotary plate and is in the form of a conical Asian hat is installed on a support rod protruding from the rotary plate, and an oil collection port is installed between the rotary plate and the roasting plate.

Finally, Korean Patent Registration No. 10-0645031 (Nov. 3, 2006) discloses a top-down direct fire roasting device in which a roasting plate on which food ingredients are placed is configured to be rotatable, a burner, serving as a heat source, sprays flame from the top to the bottom of the roasting plate, and thus upper surfaces of the food ingredients placed on the roasting plate are baked by the flames of the burner.

### DISCLOSURE

### Technical Problem

As described above, a rotary roaster according to the related art has a structure in which a roasting plate on which food ingredients are placed is rotated, and heat provided from a heat source is evenly transferred to the roasting plate without temperature deviation, but since only one sides of the food ingredients placed on the roasting plate are baked, the food ingredients need to be turned over frequently so that the food ingredients do not burn.

The present invention is directed to providing a rotary roaster having a novel structure in which a roasting plate rotates, the rotary roaster being configured so that even when a user does not turn over the food ingredients, such as meat, placed on the roasting plate one by one, the food ingredients placed thereon are automatically turned over while the roasting plate rotates, and thus the user may evenly bake and cook various kinds of food ingredients without burning the food ingredients.

### Technical Solution

One aspect of the present invention provides a rotary roaster including: a roasting plate on which food ingredients are placed and baked; a base member that supports the roasting plate and includes a heating unit configured to transfer heat to a bottom surface of the roasting plate and an edge part surrounding the roasting plate; a rotary unit that is installed in the base member and rotates the roasting plate; and a resistance holder that is spaced apart from an upper surface of the roasting plate by a predetermined distance in a state of being supported by the edge part of the base member, and evenly turns over the food ingredients by coming into contact with the food ingredients placed on the roasting plate when the roasting plate rotates.

The resistance holder may include a center part disposed in a center of the roasting plate, a plurality of extension wing parts that extend from the center part in a radial shape or a straight shape and come into contact with the food ingredients placed on the roasting plate, and end support parts that extend from ends of the extension wing parts and are supported by the edge part of the base member to be movable in a vertical direction.

The rotary unit may include a driving gear installed in the base member and a driving shaft and a driving motor connected to the driving gear, and a screw track that is engaged with the driving gear and rotates the roasting plate may be installed in the bottom surface of the roasting plate.

### Advantageous Effects

In a rotary roaster according to the present invention, when the roasting plate rotates, a resistance holder supported by the base member comes into contact with food ingredients placed on the roasting plate and turns the food ingredients over evenly, and thus the food ingredients can be easily baked and cooked without burning the food ingredients.

Although the rotary roaster according to the present invention is suitable for cooking meat ingredients, the use thereof is not limited to the meat ingredients, and the rotary roaster can be effectively used to cook food ingredients such as various grains, seafood, agricultural products, and processed foods.

### DESCRIPTION OF DRAWINGS

FIG. 1 is a view showing a rotary roaster according to a related art.

FIG. 2 is a perspective view of a rotary roaster according to one embodiment of the present invention.

FIG. 3 is an exploded perspective view of FIG. 2.

FIG. 4 is a perspective view showing a base member and a rotary unit.

FIG. 5 is a bottom view of a roasting plate of FIG. 2.

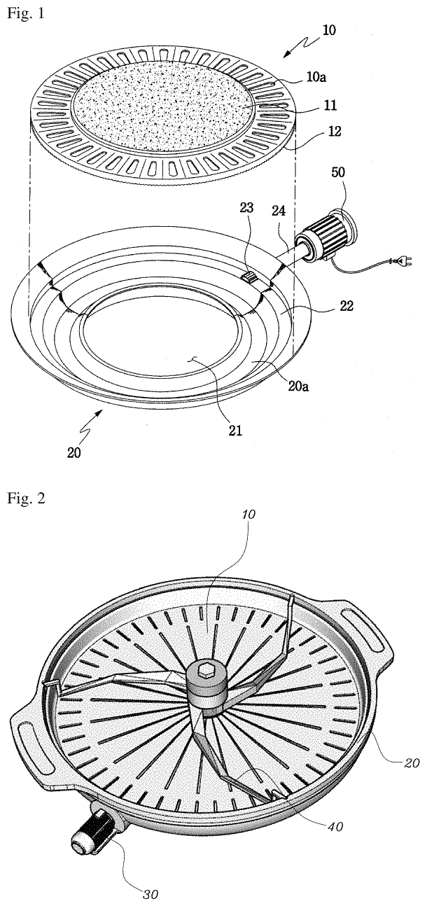

### MODES OF THE INVENTION

Hereinafter, the present invention will be described in detail with reference to the accompanying drawings. However, since the accompanying drawings illustrate exemplary embodiments of the present invention, the protection scope of the present invention is not limited by these embodiments. Further, even though matters are necessary configurations for implementing the present invention, the detailed description of matters that are introduced in the related art or that may be easily implemented by those skilled in the art will be omitted.

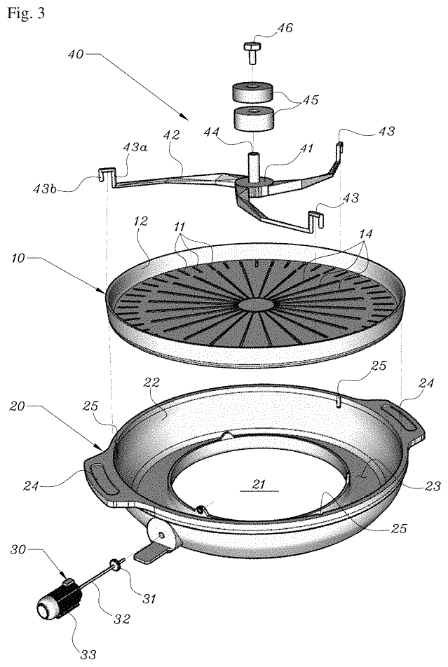

As shown in FIGS. 2 and 3, a rotary roaster according to the present invention includes a roasting plate 10 on which food ingredients are placed and baked, a base member 20 that supports the roasting plate 10, a rotary unit 30 that rotates the roasting plate 10, and a resistance holder 40 that turns over the food ingredients placed on the roasting plate 10.

First, it is preferable that the roasting plate 10 is made of a metal material in the shape of a disk like a roasting plate according to the related art, and for example, an annular step part 12 that prevents the food ingredients from escaping outward from the roasting plate 10 together with an oil discharge hole 11, through which oil that flows out in a process of cooking the food ingredients such as meat is discharged to the bottom, may be installed.

Next, the base member 20 has a heating unit that transfers heat to the bottom surface of the roasting plate 10 and an edge part 22 that accommodates and surrounds the roasting plate 10. The heating unit may be integrally installed in the base member 20 and may transfer heat provided from a heat source such as a charcoal fire or a gas burner to the bottom surface of the roasting plate 10 through a central hole 21. Further, an oil reception groove 23 that supports the oil falling from the oil discharge hole 11 may be formed between the central hole 21 and the edge part 22, and handles 24 may be installed on two sides of the edge part 22.

The rotary unit 30 is installed in the base member 20 and may have any structure as long as the structure rotates the roasting plate 10 on the base member 20 in a horizontal direction.

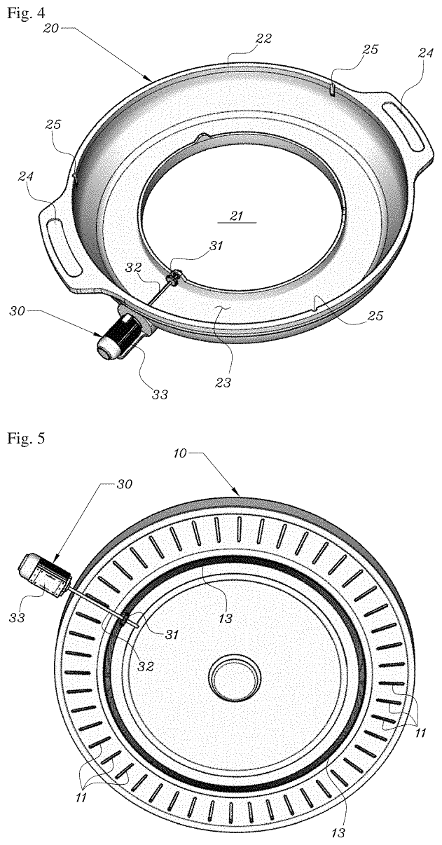

According to one embodiment of the present invention, as shown in FIGS. 3 and 4, the rotary unit 30 may include a driving gear 31 installed in the base member 20 and a driving shaft 32 and a driving motor 33 connected to the driving gear 31. Further, as shown in FIG. 5, a screw track 13 that is engaged with the driving gear 31 and rotates the roasting plate 10 may be installed on the bottom surface of the roasting plate 10.

In addition, in the base member 20, an idle roller that supports the bottom surface of the roasting plate 10 may be installed in place so that the roasting plate 10 rotates smoothly without noise. However, the idle roller is not shown in the accompanying drawings.

Finally, the resistance holder 40 is spaced apart from an upper surface of the roasting plate 10 by a predetermined distance in a state of being supported by the edge part 22 of the base member 20 and functions to turn over the food ingredients by coming into contact with the food ingredients placed on the roasting plate 10 when the roasting plate 10 rotates.

According to an exemplary embodiment of the present invention, as shown in FIG. 3, the resistance holder includes a center part 41, extension wing parts 42, and end support parts 43. First, the center part 41 is a central portion of the extension wing parts 42 and is disposed in the center of the roasting plate 10.

Next, the extension wing parts 42 extend from the center part 41 in a radial shape like spokes or extend in a straight line like both wings and are spaced apart from each other by a predetermined distance on the upper surface of the roasting plate 10. Thus, when the roasting plate 10 rotates, the food ingredients placed thereon are caught by the extension wing parts 42 and are turned over while rotation is blocked or turned over while riding over the extension wing parts 42.

The present invention exemplifies a structure in which three extension wing parts 42 are arranged at an interval of 120 degrees, but two extension wing parts 42 may be arranged at an interval of 180 degrees or four extension wing parts 42 may be arranged at an interval of 90 degrees.

Finally, the end support parts 43 are supported by the edge part 22 of the base member 20 at ends of the extension wing parts 42 and are movable in a vertical direction, but the movement thereof in a circumferential direction is limited. Thus, when the roasting plate 10 rotates, the end support parts 43 function to hold the resistance holder 40 so that the resistance holder 40 does not rotate along the roasting plate 10.

Meanwhile, as shown in FIG. 3, a central shaft 44 protrudes from the center part 41 of the resistance holder 40, and a weight part 45 that presses the center part 41 is inserted into the central shaft 44. It is preferable that a closing bolt 46, which prevents the weight part 45 from being separated, is fastened to an end of the central shaft 44.

The weight part 45 functions to add an appropriate load to the resistance holder 40 so that the extension wing parts 42 may more effectively turn over the food ingredients on the roasting plate 10 and is configured so that the weight thereof may be adjusted according to the types of the food ingredients.

Further, according to an exemplary embodiment of the present invention, the end support parts 43 of the resistance holder 40 each include an upward bent portion 43a and a downward bent portion 43b that bypass the annular step part 12 so as not to come into contact with the annular step part 12 of the roasting plate 10, and as shown in FIGS. 3 and 4, rotation prevention grooves 25 that accommodate the downward bent portion 43b to be movable only in the vertical direction are formed in the edge part 22 of the base member 20.

Further, it is preferable that the extension wing parts 42 have a curved structure in which, when the roasting plate 10 rotates, a central portion thereof is gently recessed in a rotational direction of the roasting plate 10 so that the food ingredients placed on the roasting plate 10 are not pushed out to the edge of the roasting plate 10, and in particular, the front surface of the curved part, with which the food ingredients are in contact, forms an inclined surface so that the food ingredients may easily ride thereover.

It is preferable that a friction protrusion 14 protrudes from the upper surface of the roasting plate 10 to provide a frictional force between the roasting plate 10 and the food ingredients and, at the same time, to prevent the food ingredients placed on the roasting plate 10 from sticking. The friction protrusion 14 may have a simple protrusion shape but is preferably disposed radially from the center of the roasting plate 10 and functions to help the extension wing parts 42 to more effectively turn over the food ingredients rotating along the roasting plate 10.

DESCRIPTION OF REFERENCE NUMERALS

| | |
|---|---|
| 10; roasting plate | 11; oil discharge hole |
| 12; annular step part | 13; screw track |
| 14; friction protrusion | |
| 20; base member | 21; central hole |
| 22; edge part | 23; oil reception groove |
| 24; handle | 25; rotation prevention groove |
| 30; rotary unit | 31; driving gear |
| 32; driving shaft | 33; driving motor |
| 40; resistance holder | 41; center part |
| 42; extension wing part | 43, 43a, 43b; end support part |
| 44; central shaft | 45; weight part |
| 46; closing bolt | |

1. A rotary roaster comprising:
a roasting plate on which food ingredients are placed and baked;
a base member that supports the roasting plate and includes a heating unit configured to transfer heat to a bottom surface of the roasting plate and an edge part surrounding the roasting plate;
a rotary unit that is installed in the base member and rotates the roasting plate; and
a resistance holder that is spaced apart from an upper surface of the roasting plate by a predetermined distance in a state of being supported by the edge part of the base member and evenly turns over the food ingredients by coming into contact with the food ingredients placed on the roasting plate when the roasting plate rotates.

2. The rotary roaster of claim 1, wherein the resistance holder includes a center part disposed in a center of the roasting plate, a plurality of extension wing parts that extend from the center part in a radial shape or a straight shape and come into contact with the food ingredients placed on the roasting plate, and end support parts that extend from ends of the extension wing parts and are supported by the edge part of the base member to be movable in a vertical direction.

3. The rotary roaster of claim 2, wherein a central shaft protrudes from the center part of the resistance holder, and a weight part of which a weight is adjustable is inserted into the central shaft.

4. The rotary roaster of claim 2, wherein the end support parts of the resistance holder each have a structure having an upward bent portion and a downward bent portion to bypass an annular step part of the roasting plate without contacting the annular step part, and rotation prevention grooves that accommodate the downward bent portion to be movable in the vertical direction are formed in the edge part of the base member.

5. The rotary roaster of claim 2, wherein the extension wing parts are formed in a curved structure in which a central portion is gently recessed in a rotation direction of the roasting plate, and a friction protrusion configured to increase a frictional force with respect to the food ingredients placed on the upper surface of the roasting plate is installed on the upper surface of the roasting plate.

6. The rotary roaster of claim 1, wherein the rotary unit includes a driving gear installed in the base member and a driving shaft and a driving motor connected to the driving gear, and a screw track that is engaged with the driving gear and rotates the roasting plate is installed in the bottom surface of the roasting plate.
